(19) United States
(12) Patent Application Publication
(10) Pub. No.: US 2015/0336422 A1
(43) Pub. Date: Nov. 26, 2015

(54) APPARATUS FOR PAINT ROLLER INCLUDES PAINT-RECEIVABLE TRAY

(71) Applicant: Luigi Tuzi, Richmond Hill (CA)

(72) Inventor: Luigi Tuzi, Richmond Hill (CA)

(21) Appl. No.: 14/716,634

(22) Filed: May 19, 2015

(30) Foreign Application Priority Data
May 26, 2014 (CA) 2852321

(51) Int. Cl. B44D 3/12

(52) U.S. Cl. CPC B44D 3/126

(57) ABSTRACT

An apparatus is for a paint roller. The apparatus includes a paint-receivable tray. The paint-receivable tray includes spaced apart peripheral lateral sidewalls configured to extend toward and contact a working surface once the paint-receivable tray is placed on the working surface. The paint-receivable tray also includes spaced apart peripheral end walls configured to extend toward and remain spaced apart from the working surface once the paint-receivable tray is placed on the working surface. This is done in such a way that the sliding resistance of the paint-receivable tray is reduced, at least in part, once the paint-receivable tray is urged to travel along the working surface.

### TECHNICAL FIELD

This document relates to the technical field of (and is not limited to) an apparatus for a paint roller in which the apparatus includes (and is not limited to) a paint-receivable tray.

### BACKGROUND

A paint-receivable tray is configured to contain paint to be picked up by a paint roller. The paint roller is a paint application tool used for painting large flat surfaces rapidly and efficiently.

### SUMMARY

It will be appreciated that there exists a need to mitigate (at least in part) at least one problem associated with the existing paint-receivable trays (also called existing technology). After much study of the known systems and methods with experimentation, an understanding of the problem and its solution has been identified and is articulated as follows:

A problem associated with the existing technology is that the existing paint-receivable trays do not slide easily and conveniently along a working surface (such as a drop sheet). The sliding resistance of the paint-receivable tray is too high and, as a result, the paint-receivable tray may inadvertently catch (at least in part) and drag the drop sheet as the paint-receivable tray is dragged or moved along the working surface. For instance, the paint-receivable tray does not slide relatively easily along the drop sheet, and (as a result) the paint-receivable tray inadvertently (and inconveniently) drags the drop sheet along with the existing paint-receivable tray when a painter (a user) pulls or moves the paint-receivable tray closer to himself. What is needed is a solution to the above-identified problem.

To mitigate, at least in part, at least one problem associated with the existing technology, there is provided (in accordance with a first major aspect) an apparatus 100. The apparatus 100 is for a paint roller 900. The apparatus 100 includes a paint-receivable tray 102. The paint-receivable tray 102 includes a synergistic combination of spaced apart peripheral lateral sidewalls 110 and spaced apart peripheral end walls 112. The spaced apart peripheral lateral sidewalls 110 are configured to extend toward and contact a working surface 902 (depicted in FIG. 2) once the paint-receivable tray 102 is placed on the working surface 902. The working surface 902 may include a floor, a drop sheet placed on the floor, etc., and any equivalent thereof. The spaced apart peripheral end walls 112 are configured to extend toward and remain spaced apart from the working surface 902 once the paint-receivable tray 102 is placed on the working surface 902. This is done in such a way that the sliding resistance of the paint-receivable tray 102 is reduced, at least in part, once the paint-receivable tray 102 is urged to travel along the working surface 902. A technical effect of the apparatus 100 of the first major embodiment is that the sliding resistance of the paint-receivable tray 102 is reduced as a result of the spaced apart peripheral end walls 112 extending toward and remaining spaced apart from the working surface 902 once the paint-receivable tray 102 is placed on and moved (urged to move) along the working surface 902 just so. For instance, the paint-receivable tray 102 may slide relatively easily along the drop sheet (without dragging the drop sheet along with the paint-receivable tray 102) when a painter (a user) desires (needs) to pull the paint-receivable tray 102 closer to himself.

To mitigate, at least in part, at least one problem associated with the existing technology, there is provided (in accordance with a first major aspect) an apparatus 100. The apparatus 100 is for a paint roller 900. The apparatus 100 includes a paint-receivable tray 102. The paint-receivable tray 102 includes a synergistic combination of a sloped floor 104, spaced apart raised ribs 106, a paint collection well 108, the spaced apart peripheral lateral sidewalls 110 and the spaced apart peripheral end walls 112. The sloped floor 104 is configured to facilitate the movement of the paint flow once the paint is received by the sloped floor 104. The spaced apart raised ribs 106 extend upwardly from the sloped floor 104. The spaced apart raised ribs 106 are configured to urge the movement of the excess paint from the paint roller 900 toward a portion of the sloped floor 104 once the paint roller 900 is rolled along a length of the sloped floor 104 just so. The paint collection well 108 extends from the sloped floor 104. The paint collection well 108 is configured (shaped) to receive the paint flow from the sloped floor 104. The spaced apart peripheral lateral sidewalls 110 extend along opposite elongated lateral sides (the end sections) of the sloped floor 104 and the paint collection well 108. The spaced apart peripheral lateral sidewalls 110 are configured to extend toward and contact the working surface 902 (depicted in FIG. 2) once the paint-receivable tray 102 is placed on the working surface 902. The spaced apart peripheral end walls 112 extend along opposite end sides (end sections) of the sloped floor 104 and the paint collection well 108. The spaced apart peripheral end walls 112 are oriented perpendicularly to the spaced apart peripheral lateral sidewalls 110. The spaced apart peripheral end walls 112 are configured to extend toward and remain spaced apart from the working surface 902 once the paint-receivable tray 102 is placed on the working surface 902. This is done in such a way that the sliding resistance of the paint-receivable tray 102 is reduced, at least in part, once the paint-receivable tray 102 is urged to travel along the working surface 902, while the paint-receivable tray 102 remains in contact with the working surface 902 through a travel direction that extends along a laterally-extending length of the spaced apart peripheral lateral sidewalls 110. A technical effect of the apparatus 100 of the second major embodiment is that the sliding resistance of the paint-receivable tray 102 is reduced as a result of the spaced apart peripheral end walls 112 extending toward and remaining spaced apart from the working surface 902 once the paint-receivable tray 102 is placed on and moved (urged to move) along the working surface 902 just so. For instance, the paint-receivable tray 102 may slide relatively easily along the drop sheet (without dragging the drop sheet along with the paint-receivable tray 102) when a painter (a user) desires (needs) to pull the paint-receivable tray 102 closer to himself.

Another problem associated with the existing technology is that the existing paint-receivable trays do not provide a way for the user (the painter) to unfreeze a stuck or frozen instance of the paint roller 900, which may reduce time for such work thereby permitting more time for painting duties. What is needed is a solution for this problem (as well).

To mitigate, at least in part, at least one problem associated with the existing technology, there is provided (in accordance with a first major aspect) an apparatus 100. The apparatus 100 is for a paint roller 900. The apparatus 100 includes a paint-receivable tray 102. The paint-receivable tray 102 includes a synergistic combination of the sloped floor 104, the spaced apart raised ribs 106, and spaced apart raised ridges 114. The sloped floor 104 is configured to facilitate the movement of the paint flow once the paint is received by the sloped floor 104. The spaced apart raised ribs 106 extend upwardly from the sloped floor 104. The spaced apart raised ribs 106 are configured to urge the movement of the excess paint from the paint roller 900 toward a portion of the sloped floor 104 once the paint roller 900 is rolled along a length of the sloped floor 104 just so. The spaced apart raised ridges 114 extend from the sloped floor 104 and extend above the spaced apart raised ribs 106. The spaced apart raised ridges 114 are configured to unstick a frozen instance of the paint roller 900 once the frozen instance of the paint roller 900 is forced to move along the spaced apart raised ridges 114. It will be appreciated that FIGS. 8A and 8B depict detailed views of the embodiments of the spaced apart raised ridges 114. A technical effect associated with the spaced apart raised ridges 114 of the apparatus 100 of the third major embodiment is that the spaced apart raised ridges 114 provide a convenient way for the user (the painter) to unfreeze a stuck or frozen instance of the paint roller 900, which may reduce time for such work thereby permitting more time for painting duties.

Another problem associated with the existing technology is that the existing paint-receivable trays do not provide a way for the user (the painter) to move the paint-receivable tray across the working surface (without having to pick up the existing paint-receivable tray and move the existing paint-receivable tray above the working surface). What is needed is a solution for this problem (as well).

To mitigate, at least in part, at least one problem associated with the existing technology, there is provided (in accordance with a first major aspect) an apparatus 100. The apparatus 100 is for a paint roller 900. The apparatus 100 includes the paint-receivable tray 102. The paint-receivable tray 102 includes a synergistic combination of the sloped floor 104 and a paint-roller engaging device 116. The sloped floor 104 is configured to facilitate the movement of the paint flow once the paint is received by the sloped floor 104. The paint-roller engaging device 116 is positioned proximate to the sloped floor 104. The paint-roller engaging device 116 extends into an interior of the paint-receivable tray 102. The paint-roller engaging device 116 is configured to receive and make contact (contact engagement) with the paint roller 900 once the paint roller 900 is positioned and received by the paint-roller engaging device 116. It will be appreciated that FIG. 3 depicts a detailed view of an embodiment of the paint-roller engaging device 116. A technical effect associated with the paint-roller engaging device 116 of the apparatus 100 of the fourth major embodiment is that the paint-roller engaging device 116 provides a convenient way for the user (the painter) to move the paint-receivable tray 102 across the working surface 902 (without having to pick up the paint-receivable tray 102 and move the paint-receivable tray 102 above the working surface 902).

Another problem associated with the existing technology is that the paint-receivable tray (of the existing technology) does not provide a way for the user to grab (get a relatively firmer grip on) the paint-receivable tray. In addition, another problem is that the cost of manufacturing the paint-receivable tray is relatively high on account of the amount of material used in forming the paint-receivable tray. What is needed is a solution for these problems.

To mitigate, at least in part, at least one problem associated with the existing technology, there is provided (in accordance with a first major aspect) an apparatus 100. The apparatus 100 is for a paint roller 900. The apparatus 100 of the fifth major embodiment includes the paint-receivable tray 102. The paint-receivable tray 102 includes a synergistic combination of the spaced apart peripheral lateral sidewalls 110, the spaced apart peripheral end walls 112 and a wall notch 118. The spaced apart peripheral lateral sidewalls 110 are configured to extend toward the working surface 902 (depicted in FIG. 2) once the paint-receivable tray 102 is placed on the working surface 902. The spaced apart peripheral end walls 112 are configured to extend toward the working surface 902 once the paint-receivable tray 102 is placed on the working surface 902. Any one of the spaced apart peripheral lateral sidewalls 110 and the spaced apart peripheral end walls 112 define the wall notch 118 (at least one or more instances of the wall notch 118). A technical effect associated with the wall notch 118 of the apparatus 100 of the fifth major embodiment is that the amount of materials (such as plastic material, etc.) used to form the paint-receivable tray 102 is reduced, at least in part. In this manner, the cost of manufacturing the paint-receivable tray 102 may be realized (by the reduction of materials used to form the paint-receivable tray 102). In addition, another technical effect of the wall notch 118 is that the wall notch 118 provides a convenient way for the user to grab (get a relatively firmer grip on) the paint-receivable tray 102.

It will be appreciated that the components of the paint-receivable tray 102 (such as, the sloped floor 104, the spaced apart raised ribs 106, the paint collection well 108, the spaced apart peripheral lateral sidewalls 110, the spaced apart peripheral end walls 112, the spaced apart raised ridges 114, the paint-roller engaging device 116 and the wall notch 118) may be mixed and matched in such a way as to provide optional configurations of the paint-receivable tray 102.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 and FIG. 2 depict a perspective view and an end view (respectively) of embodiments of an apparatus 100 including a paint-receivable tray 102;

FIG. 3 depicts a perspective view of an embodiment of the apparatus 100 of FIG. 1;

FIG. 4 and FIG. 5 depict perspective views of embodiments of the apparatus 100 of FIG. 1;

FIG. 6 and FIG. 7 depict a side perspective view and an end perspective view (respectively) of embodiments of the apparatus 100 of FIG. 1;

FIG. 8A and FIG. 8B depict cross-sectional side views of embodiments of the apparatus 100 of FIG. 1;

FIG. 9 depicts a perspective side view of an embodiment of the apparatus 100 of FIG. 1; and

FIG. 10 depicts a perspective side view of an embodiment of the apparatus 100 of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 paint-receivable tray
104 sloped floor section
106 spaced apart raised ribs
108 paint collection well
110 spaced apart peripheral lateral sidewalls
112 spaced apart peripheral end walls
114 spaced apart raised ridges
116 paint-roller engaging device
118 wall notch
120 smooth rounded edges
121 sliding edge
122 first bracket assembly
124 second bracket assembly
126 ladder-engagement device
900 paint roller
902 working surface
904 handle section
906 roller frame
908 roller cover
910 direction

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

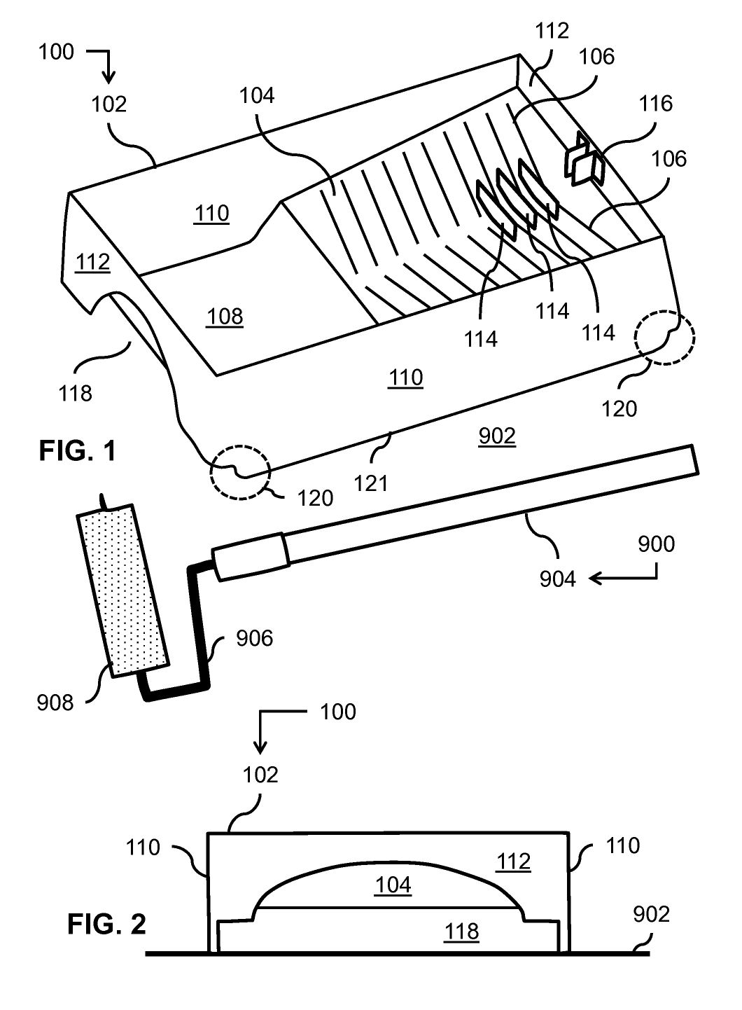

FIG. 1 and FIG. 2 depict a perspective view and an end view (respectively) of embodiments of an apparatus 100 including a paint-receivable tray 102.

In accordance with a first major embodiment, the apparatus 100 is for a paint roller 900. It is understood that the apparatus 100 does not include the paint roller 900. The paint-receivable tray 102 is configured to receive the paint (from a paint can, for instance). The paint roller 900 is used (by the user) in such a way that the paint roller 900 (in use) picks up an amount of paint that is held by the paint-receivable tray 102, and the user then rolls the paint roller 900 along a surface to be painted. From time to time, the paint-receivable tray 102 needs to be moved (in a convenient and relatively easy manner) to a place where the user (the painter) needs to apply some paint to an unpainted surface (such as a wall surface, etc.), thereby providing more effective time for painting duties, etc. From time to time, the paint roller 900 may become frozen with accumulated paint, and the user needs to unfreeze the paint roller 900 (in order to get the paint roller 900 to roll in an operative manner) while remaining in close proximity to the paint-receivable tray 102, thereby providing more effective time for painting duties, etc.

In accordance with an embodiment, the paint roller 900 includes (for instance) a roller frame 906 and a roller cover 908. The roller cover 908 is configured to absorb paint held in the paint-receivable tray 102 and transfers (in use) the paint to a surface to be painted (once the user positions the paint roller 900 to do just so). The roller frame 906 is configured to attach to the roller cover 908 (in such a way that the roller cover 908 may be rotated). A painter (user) holds the paint roller 900 by a handle section 904. The handle section 904 may be elongated (if so desired). The roller frame 906 is reusable. It is possible to clean and reuse the roller cover 908. However, the roller cover 908 may be disposed of after use (if so desired). The roller cover 908 includes a cylindrical core with a pile fabric covering secured to the cylindrical core. Foam rubber rollers may also be used (if so desired). There are both foam and fabric rollers that are individually available (without a handle), and made to replace worn out rollers. Once an old roller cover is removed from the roller frame 906, a new roller cover can be fitted onto the roller frame 906 (for subsequent use).

The apparatus 100 of the first major embodiment includes (and is not limited to) a paint-receivable tray 102. The paint-receivable tray 102 includes (and is not limited to) a synergistic combination of spaced apart peripheral lateral sidewalls 110 and spaced apart peripheral end walls 112. The spaced apart peripheral lateral sidewalls 110 are configured to extend toward and contact a working surface 902 (depicted in FIG. 2) once the paint-receivable tray 102 is placed on the working surface 902. The working surface 902 may include a floor, a drop sheet placed on the floor, etc., and any equivalent thereof. The spaced apart peripheral end walls 112 are configured to extend toward and remain spaced apart from the working surface 902 once the paint-receivable tray 102 is placed on the working surface 902. This is done in such a way that the sliding resistance of the paint-receivable tray 102 is reduced, at least in part, once the paint-receivable tray 102 is urged to travel along the working surface 902.

A technical effect of the apparatus 100 of the first major embodiment is that the sliding resistance of the paint-receivable tray 102 is reduced as a result of the spaced apart peripheral end walls 112 extending toward and remaining spaced apart from the working surface 902 once the paint-receivable tray 102 is placed on and moved (urged to move) along the working surface 902 just so. For instance, the paint-receivable tray 102 may slide relatively easily along the drop sheet (without dragging the drop sheet along with the paint-receivable tray 102) when a painter (a user) desires (needs) to pull the paint-receivable tray 102 closer to himself.

In accordance with a second major embodiment, the apparatus 100 is for the paint roller 900. It is understood that the apparatus 100 does not include the paint roller 900. The apparatus 100 of the second major embodiment includes (and is not limited to) the paint-receivable tray 102. The paint-receivable tray 102 includes (and is not limited to) a synergistic combination of a sloped floor section 104, spaced apart raised ribs 106, a paint collection well 108, the spaced apart peripheral lateral sidewalls 110 and the spaced apart peripheral end walls 112. The sloped floor section 104 is configured to facilitate the movement of the paint flow once the paint is received by the sloped floor section 104. The spaced apart raised ribs 106 extend upwardly from the sloped floor section 104. The spaced apart raised ribs 106 are configured to urge the movement of the excess paint from the paint roller 900 toward a portion of the sloped floor section 104 once the paint roller 900 is rolled along a length of the sloped floor section 104 just so. The paint collection well 108 extends from the sloped floor section 104. The paint collection well 108 is configured (shaped) to receive the paint flow from the sloped floor section 104. The spaced apart peripheral lateral sidewalls 110 extend along opposite elongated lateral sides (the end sections) of the sloped floor section 104 and the paint collection well 108. The spaced apart peripheral lateral sidewalls 110 are configured to extend toward and contact the working surface 902 (depicted in FIG. 2) once the paint-receivable tray 102 is placed on the working surface 902. The spaced apart peripheral end walls 112 extend along opposite end sides (end sections) of the sloped floor section 104 and the paint collection well 108. The spaced apart peripheral end walls 112 are oriented perpendicularly to the spaced apart peripheral lateral sidewalls 110. The spaced apart peripheral end walls 112 are configured to extend toward and remain spaced apart from the working surface 902 once the paint-receivable tray 102 is placed on the working surface 902. This is done in such a way that the sliding resistance of the paint-receivable tray 102 is reduced, at least in part, once the paint-receivable tray 102 is urged to travel along the working surface 902, while the paint-receivable tray 102 remains in contact with the working surface 902 through a travel direction that extends along a laterally-extending length of the spaced apart peripheral lateral sidewalls 110.

A technical effect of the apparatus 100 of the second major embodiment is that the sliding resistance of the paint-receivable tray 102 is reduced as a result of the spaced apart peripheral end walls 112 extending toward and remaining spaced apart from the working surface 902 once the paint-receivable tray 102 is placed on and moved (urged to move) along the working surface 902 just so. For instance, the paint-receivable tray 102 may slide relatively easily along the drop sheet (without dragging the drop sheet along with the paint-receivable tray 102) when a painter (a user) desires (needs) to pull the paint-receivable tray 102 closer to himself.

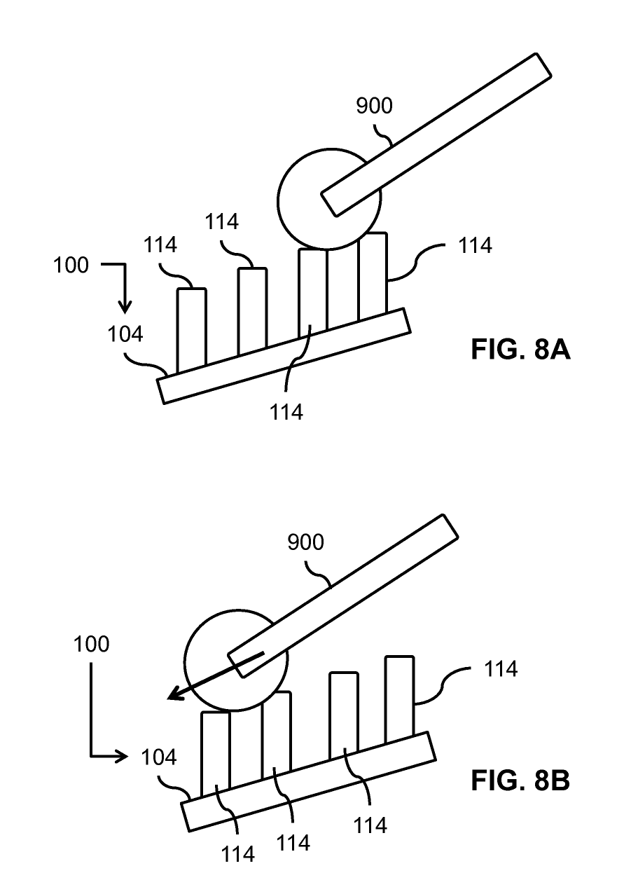

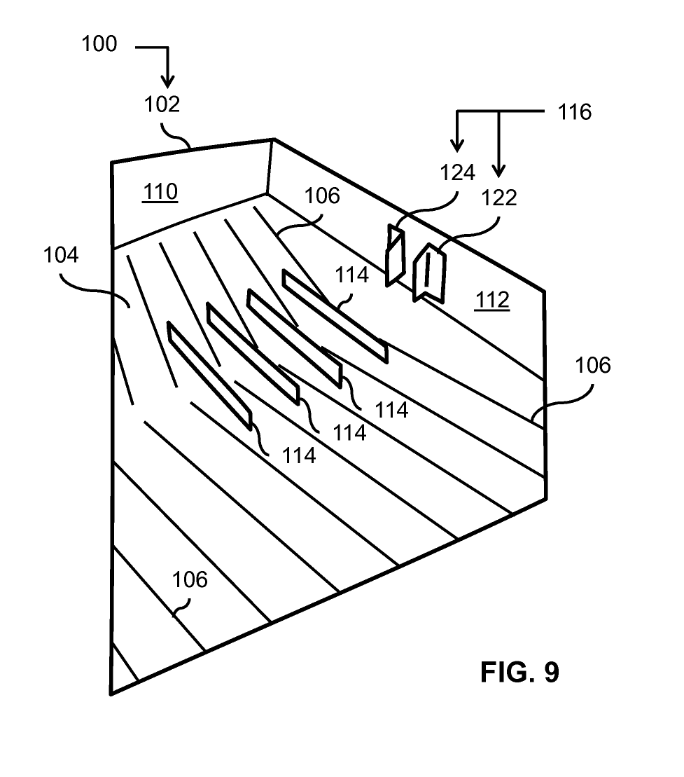

In accordance with a third major embodiment, the apparatus 100 is for the paint roller 900. It is understood that the apparatus 100 does not include the paint roller 900. The apparatus 100 of the third major embodiment includes (and is not limited to) the paint-receivable tray 102. The paint-receivable tray 102 includes (and is not limited to) a synergistic combination of the sloped floor section 104, the spaced apart raised ribs 106, and spaced apart raised ridges 114. The sloped floor section 104 is configured to facilitate the movement of the paint flow once the paint is received by the sloped floor section 104. The spaced apart raised ribs 106 extend upwardly from the sloped floor section 104. The spaced apart raised ribs 106 are configured to urge the movement of the excess paint from the paint roller 900 toward a portion of the sloped floor section 104 once the paint roller 900 is rolled along a length of the sloped floor section 104 just so. The spaced apart raised ridges 114 extend from the sloped floor section 104 and extend above the spaced apart raised ribs 106. The spaced apart raised ridges 114 are configured to unstick a frozen instance of the paint roller 900 once the frozen instance of the paint roller 900 is forced to move along the spaced apart raised ridges 114. It will be appreciated that FIGS. 8A and 8B depict detailed views of the embodiments of the spaced apart raised ridges 114.

A technical effect associated with the spaced apart raised ridges 114 of the apparatus 100 of the third major embodiment is that the spaced apart raised ridges 114 provide a convenient way for the user (the painter) to unfreeze a stuck or frozen instance of the paint roller 900, which may reduce time for such work thereby permitting more time for painting duties.

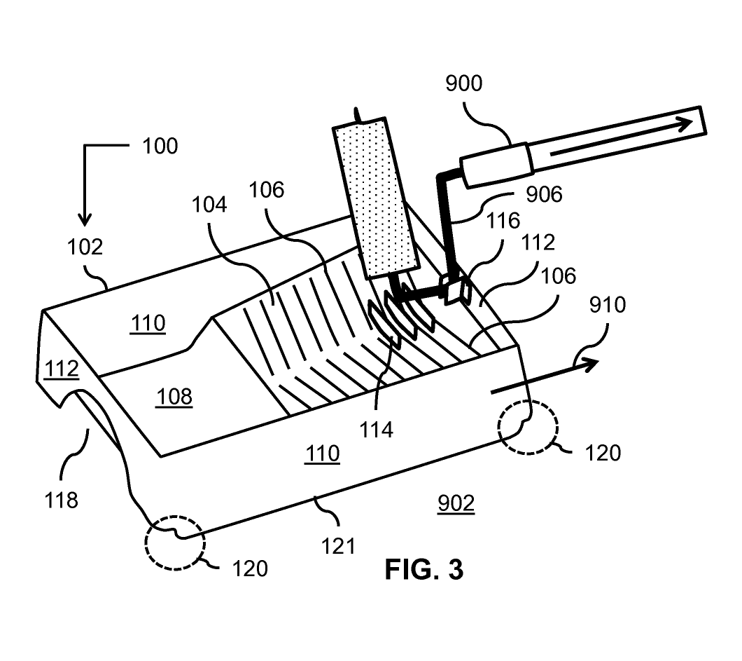

In accordance with a fourth major embodiment, the apparatus 100 is for the paint roller 900. It is understood that the apparatus 100 does not include the paint roller 900. The apparatus 100 of the fourth major embodiment includes (and is not limited to) the paint-receivable tray 102. The paint-receivable tray 102 includes (and is not limited to) a synergistic combination of the sloped floor section 104 and a paint-roller engaging device 116. The sloped floor section 104 is configured to facilitate the movement of the paint flow once the paint is received by the sloped floor section 104. The paint-roller engaging device 116 is positioned proximate to the sloped floor section 104. The paint-roller engaging device 116 extends into an interior of the paint-receivable tray 102. The paint-roller engaging device 116 is configured to receive and make contact (contact engagement) with the paint roller 900 once the paint roller 900 is positioned and received by the paint-roller engaging device 116. It will be appreciated that FIG. 3 depicts a detailed view of an embodiment of the paint-roller engaging device 116.

A technical effect associated with the paint-roller engaging device 116 of the apparatus 100 of the fourth major embodiment is that the paint-roller engaging device 116 provides a convenient way for the user (the painter) to move the paint-receivable tray 102 across the working surface 902 (without having to pick up the paint-receivable tray 102 and move the paint-receivable tray 102 above the working surface 902).

In accordance with a fifth major embodiment, the apparatus 100 is for the paint roller 900. It is understood that the apparatus 100 does not include the paint roller 900. The apparatus 100 of the fifth major embodiment includes (and is not limited to) the paint-receivable tray 102. The paint-receivable tray 102 includes (and is not limited to) a synergistic combination of the spaced apart peripheral lateral sidewalls 110, the spaced apart peripheral end walls 112 and a wall notch 118. The spaced apart peripheral lateral sidewalls 110 are configured to extend toward the working surface 902 (depicted in FIG. 2) once the paint-receivable tray 102 is placed on the working surface 902. The spaced apart peripheral end walls 112 are configured to extend toward the working surface 902 once the paint-receivable tray 102 is placed on the working surface 902. It will be appreciated that any one of the spaced apart peripheral lateral sidewalls 110 and the spaced apart peripheral end walls 112 define the wall notch 118 (at least one or more instances of the wall notch 118).

A technical effect associated with the wall notch 118 of the apparatus 100 of the fifth major embodiment is that the amount of materials (such as plastic material, etc.) used to form the paint-receivable tray 102 is reduced, at least in part. Thereby the cost of manufacturing the paint-receivable tray 102 may be realized (by using less material for forming the paint-receivable tray 102). In addition, another technical effect of the wall notch 118 is that the wall notch 118 provides a convenient way for the user to grab (get a relatively firmer grip on) the paint-receivable tray 102.

It will be appreciated that the components of the paint-receivable tray 102 (such as, the sloped floor section 104, the spaced apart raised ribs 106, the paint collection well 108, the spaced apart peripheral lateral sidewalls 110, the spaced apart peripheral end walls 112, the spaced apart raised ridges 114, the paint-roller engaging device 116 and the wall notch 118) may be mixed and matched in such a way as to provide optional configurations of the paint-receivable tray 102.

Referring to the embodiments as depicted in FIG. 1 and FIG. 2, the paint-receivable tray 102 may be made from a material that is formed by using an injection molding process. Injection molding is a manufacturing process for producing parts by injecting material into a mold. Injection molding can be performed with a host of materials, including metals, glasses, elastomers, confections, thermoplastic and/or thermosetting polymers. Material for the paint-receivable tray 102 is fed into a heated barrel, mixed, and forced into a mold cavity formed by the mold, where the material cools and hardens to the configuration of the cavity. The molds for receiving the material are made from metal, usually either steel or aluminum, and precision-machined to form the technical features of the paint-receivable tray 102. Alternatively, 3D printing technology may be used to form the paint-receivable tray 102 (if so desired) by using a suitable printing polymer.

Referring to the embodiment as depicted in FIG. 1, the spaced apart peripheral lateral sidewalls 110 define smooth rounded edges 120 positioned at opposite sides (opposite lateral sides) of the spaced apart peripheral lateral sidewalls 110. This is done in such a way that once the paint-receivable tray 102 is moved along the working surface 902, the spaced apart peripheral lateral sidewalls 110 are less likely to inadvertently catch (at least in part) the working surface 902 (thereby reducing the possibility of accidentally spilling paint from the tray to the working surface 902).

Preferably, the spaced apart peripheral lateral sidewalls 110 each provides a sliding edge 121 configured to make contact with the working surface 902.

Referring to the embodiment as depicted in FIG. 2, the spaced apart peripheral lateral sidewalls 110 are configured to extend in such a way that the spaced apart peripheral lateral sidewalls 110 can make contact with the working surface 902 (such as a drop sheet) while the spaced apart peripheral end walls 112 do not make contact with the working surface 902. This is done in such a way that the paint-receivable tray 102 may be more easily moved along the working surface 902 (with relatively less friction), thereby reducing the possibility of inadvertently spilling paint from the paint-receivable tray 102.

It will be appreciated that in accordance with an optional embodiment (if so desired), the opposite spaced apart peripheral end walls 112 are configured to extend in such a way that the spaced apart peripheral end walls 112 can make contact with the working surface 902 (such as a drop sheet) while the spaced apart peripheral lateral sidewalls 110 do not make contact with the working surface 902. This is done in such a way that the paint-receivable tray 102 may be more easily moved along the working surface 902 (with relatively less friction), thereby reducing the possibility of inadvertently spilling paint from the paint-receivable tray 102.

FIG. 3 depicts a perspective view of an embodiment of the apparatus 100 of FIG. 1.

The sloped floor section 104 is configured to facilitate the movement of the paint flow once the paint is received by the sloped floor section 104. This is done in such a way that the paint that is received (at least in part) by the sloped floor section 104 may flow towards (and into) the paint collection well 108. A thin layer of paint may remain on the sloped floor section 104 so that the paint roller 900 may pick up some paint from the sloped floor section 104 (when needed).

The paint-roller engaging device 116 is positioned proximate to the sloped floor section 104. The paint-roller engaging device 116 extends into the interior of the paint-receivable tray 102. The paint-roller engaging device 116 is configured to receive and make contact (contact engagement) with the paint roller 900 (such as the roller frame 906, etc.) once the paint roller 900 is positioned and received by the paint-roller engaging device 116. The technical effect of the paint-roller engaging device 116 is that the user is able to move the paint-receivable tray 102 to a position that is relatively closer to the user without the user having to directly pick up and move the paint-receivable tray 102.

In addition, for the case where the spaced apart peripheral lateral sidewalls 110 and the spaced apart peripheral end walls 112 are implemented as depicted in FIG. 2, once the paint-receivable tray 102 is moved along the working surface 902, the spaced apart peripheral lateral sidewalls 110 slide along (in frictional contact with) the working surface 902 (along the direction 910) while the spaced apart peripheral end walls 112 do not make frictional contact with the working surface 902. This arrangement reduces (in use) the friction of the paint-receivable tray 102 as the paint-receivable tray 102 is moved along the working surface 902.

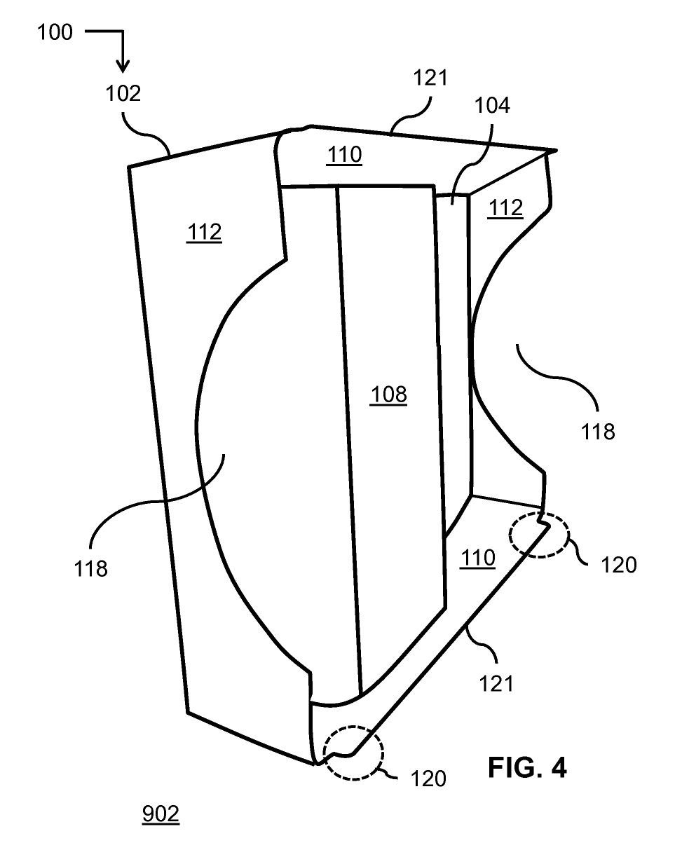

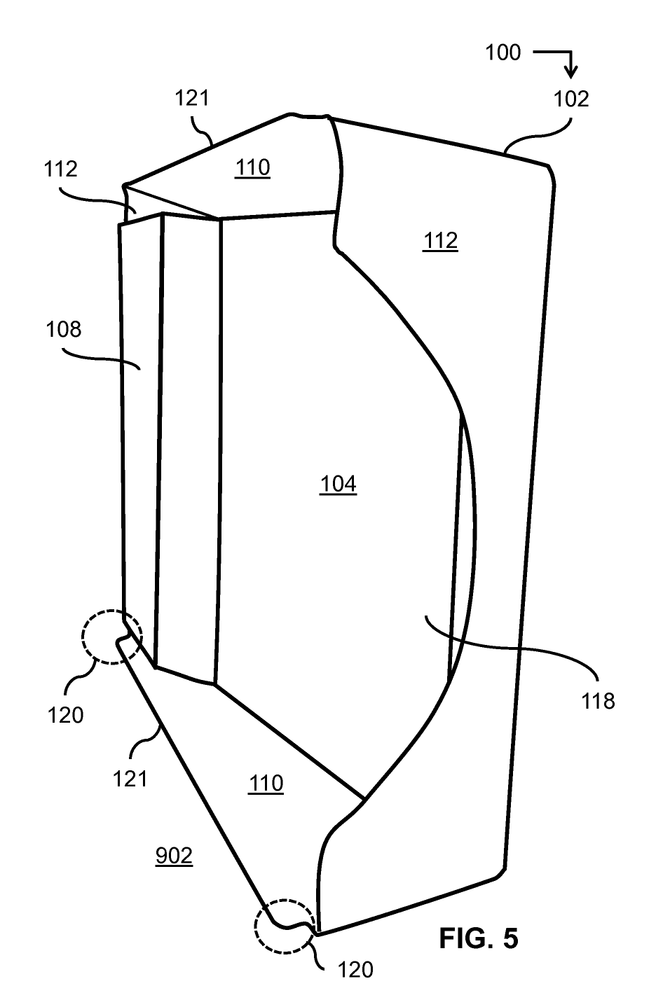

FIG. 4 and FIG. 5 depict perspective side views of embodiments (from the rear section and from the front section, respectively) of the apparatus 100 of FIG. 1.

The paint-receivable tray 102 is placed on the working surface 902 in such a way that a side section of one of the spaced apart peripheral lateral sidewalls 110 contacts the working surface 902, thereby showing the underside of the paint-receivable tray 102.

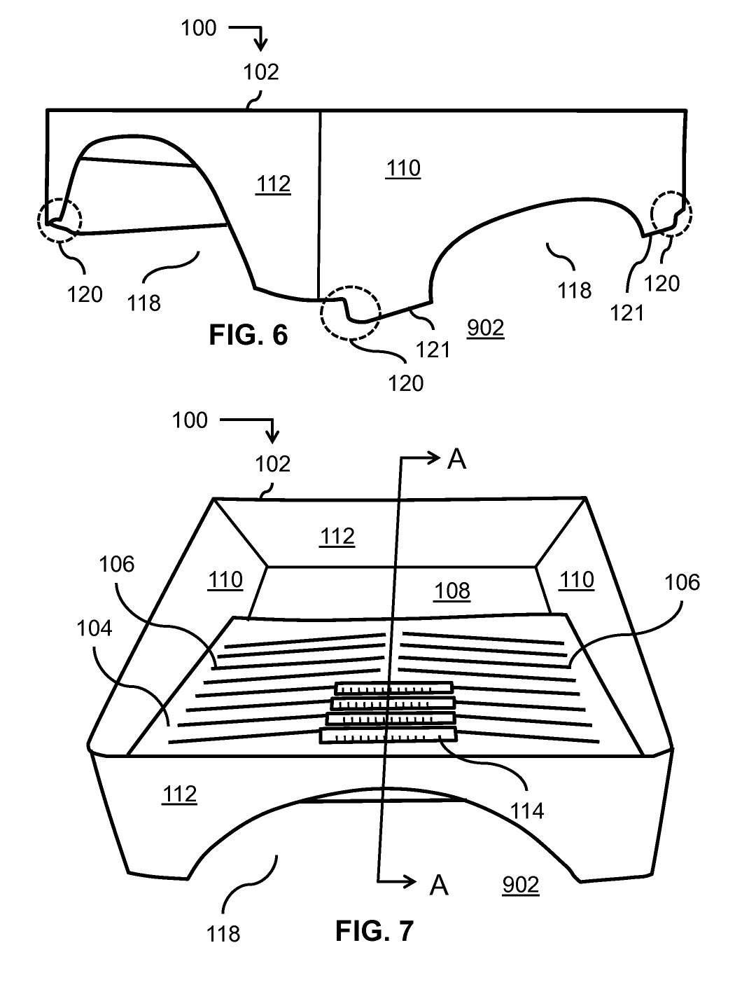

FIG. 6 and FIG. 7 depict a side perspective view and an end perspective view (respectively) of embodiments of the apparatus 100 of FIG. 1.

Referring to the embodiment as depicted in FIG. 6, it will be appreciated that any one of (or all of) the spaced apart peripheral lateral sidewalls 110 and the spaced apart peripheral end walls 112 may define the wall notch 118 (at least one or more instances of the wall notch 118). A technical effect of the wall notch 118 is to reduce the amount of material used to form the paint-receivable tray 102. Another technical effect of the wall notch 118 is to permit the user to more easily grip or grab the paint-receivable tray 102 (if so desired) in order to move the paint-receivable tray 102 along the working surface 902.

Referring to the embodiment as depicted in FIG. 7, the spaced apart raised ridges 114 are positioned in a central zone of the sloped floor section 104. The spaced apart raised ridges 114 extend into the interior of the paint-receivable tray 102 above the sloped floor section 104. Preferably, the spaced apart raised ridges 114 are positioned proximate to an instance of the spaced apart peripheral end walls 112 that extends along the sloped floor section 104. The spaced apart raised ridges 114 are positioned between selected instances of the spaced apart raised ribs 106 that extend from the sloped floor section 104. In accordance with the embodiment as depicted in FIG. 7, instances (two, three, four or more) of the spaced apart raised ridges 114 are spaced apart from each other, and are aligned along a row extending along a central section of the sloped floor section 104. The spaced apart raised ribs 106 extend upwardly from the sloped floor section 104. The spaced apart raised ribs 106 are configured to urge the movement of the excess paint from the paint roller 900 toward a portion of the sloped floor section 104 once the paint roller 900 is rolled along a length of the sloped floor section 104 just so.

FIG. 8A and FIG. 8B depict cross-sectional side views of embodiments of the apparatus 100 of FIG. 1 (taken along a cross-sectional line A-A of FIG. 7).

The spaced apart raised ridges 114 extend from the sloped floor section 104 and extend above the spaced apart raised ribs 106 (as depicted in FIG. 7). The spaced apart raised ridges 114 are configured to unstick a frozen instance of the paint roller 900 once the frozen instance of the paint roller 900 is forced to move along the spaced apart raised ridges 114.

FIG. 9 depicts a perspective side view of an embodiment of the apparatus 100 of FIG. 1.

Referring to the embodiment as depicted in FIG. 9, the spaced apart raised ridges 114 are positioned in the central zone of the sloped floor section 104. The spaced apart raised ridges 114 extend into the interior of the paint-receivable tray 102 above the sloped floor section 104. The spaced apart raised ridges 114 are positioned between selected instances of the spaced apart raised ribs 106 that extend from the sloped floor section 104. In accordance with the embodiment as depicted in FIG. 9, four instances of the spaced apart raised ridges 114 are spaced apart from each other, and are aligned along a row extending along a central section of the sloped floor section 104.

In accordance with a preferred embodiment, the paint-roller engaging device 116 includes a first bracket assembly 122 and a second bracket assembly 124 that is spaced apart from the first bracket assembly 122. The first bracket assembly 122 and the second bracket assembly 124 mounted to one of the spaced apart peripheral end walls 112 proximate to a top section of the sloped floor section 104.

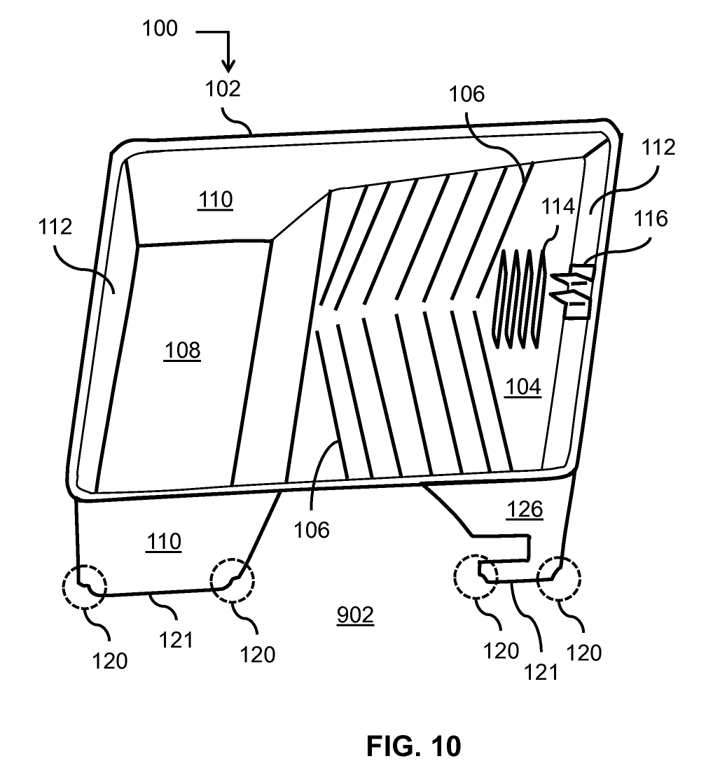

FIG. 10 depicts a perspective side view of an embodiment of the apparatus 100 of FIG. 1.

In accordance with the embodiment depicted in FIG. 10, the paint-receivable tray 102 further includes a ladder-engagement device 126 configured to extend from the sloped floor section 104, and also configured to engage (in use) a ladder (known and not depicted). The ladder-engagement device 126 is configured to facilitate movement of the paint-receivable tray 102 with less friction. Preferably, the bottom edge of the ladder-engagement device 126 provides smooth rounded edges 120. Preferably, the ladder-engagement device 126 provides a sliding edge 121 configured to make contact with the working surface 902 that is co-aligned with the sliding edge 121 provided by the spaced apart peripheral lateral sidewalls 110. In accordance with a preferred option, the paint-receivable tray 102 depicted in FIG. 10 includes or is formed from a metal material.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform the desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a paint roller, the apparatus comprising:
a paint-receivable tray, including:
spaced apart peripheral lateral sidewalls being configured to extend toward and contact a working surface once the paint-receivable tray is placed on the working surface; and
spaced apart peripheral end walls being configured to extend toward and remain spaced apart from the working surface once the paint-receivable tray is placed on the working surface in such a way that a sliding resistance of the paint-receivable tray is reduced, at least in part, once the paint-receivable tray is urged to travel along the working surface.

2. The apparatus of claim 1, further comprising:
a sloped floor section being configured to facilitate movement of paint flow once paint is received by the sloped floor section.

3. The apparatus of claim 2, further comprising:
a spaced apart raised ribs extending upwardly from the sloped floor section, the spaced apart raised ribs are configured to urge movement of excess paint from the paint roller toward a portion of the sloped floor section once the paint roller is rolled along a length of the sloped floor section just so.

4. The apparatus of claim 3, further comprising:
spaced apart raised ridges extending from the sloped floor section and extending above the spaced apart raised ribs, the spaced apart raised ridges being configured to unstick a frozen instance of the paint roller once the frozen instance of the paint roller is forced to move along the spaced apart raised ridges.

5. The apparatus of claim 1, further comprising:
a paint-roller engaging device extending into an interior of the paint-receivable tray, and the paint-roller engaging device being configured to receive and make contact with the paint roller once the paint roller is positioned and received by the paint-roller engaging device.

6. The apparatus of claim 1, wherein:
any one of the spaced apart peripheral lateral sidewalls and the spaced apart peripheral end walls defines a wall notch.

7. The apparatus of claim 1, further comprising:
a sloped floor section being configured to facilitate movement of paint flow once paint is received by the sloped floor section; and
a paint-roller engaging device being positioned proximate to the sloped floor section, and the paint-roller engaging device extending into an interior of the paint-receivable tray, and the paint-roller engaging device being configured to receive and make contact with the paint roller once the paint roller is positioned and received by the paint-roller engaging device.

8. The apparatus of claim 1, wherein:
any one of the spaced apart peripheral lateral sidewalls and the spaced apart peripheral end walls defining a wall notch.

9. The apparatus of claim 1, wherein:
the spaced apart peripheral lateral sidewalls define smooth rounded edges positioned at opposite sides of the spaced apart peripheral lateral sidewalls in such a way that once the paint-receivable tray is moved along the working surface, the spaced apart peripheral lateral sidewalls are less likely to inadvertently catch, at least in part, the working surface.

10. The apparatus of claim 1, wherein:
the spaced apart peripheral lateral sidewalls are configured to extend in such a way that the spaced apart peripheral lateral sidewalls can make contact with the working surface while the spaced apart peripheral end walls do not make contact with the working surface, and this is done in such a way that the paint-receivable tray may be more easily moved along the working surface with relatively less friction.

11. The apparatus of claim 1, wherein:
the spaced apart peripheral end walls are configured to extend in such a way that the spaced apart peripheral end walls can make contact with the working surface while the spaced apart peripheral lateral sidewalls do not make contact with the working surface, and this is done in such a way that the paint-receivable tray may be more easily moved along the working surface with relatively less friction.

12. The apparatus of claim 4, wherein:
the spaced apart raised ridges are positioned in a central zone of the sloped floor section.

13. The apparatus of claim 4, wherein:
the spaced apart raised ridges extend into the interior of the paint-receivable tray above the sloped floor section.

14. The apparatus of claim 4, wherein:
the spaced apart raised ridges are positioned proximate to an instance of the spaced apart peripheral end walls that extends along the sloped floor section.

15. The apparatus of claim 4, wherein:
the spaced apart raised ridges are positioned between selected instances of the spaced apart raised ribs that extend from the sloped floor section.

16. The apparatus of claim 4, wherein:
instances of the spaced apart raised ridges are spaced apart from each other, and are aligned along a row extending along a central section of the sloped floor section.

17. The apparatus of claim 4, wherein:
the spaced apart raised ridges are positioned in a central zone of the sloped floor section;
the spaced apart raised ridges extend into the interior of the paint-receivable tray above the sloped floor section;
the spaced apart raised ridges are positioned proximate to an instance of the spaced apart peripheral end walls that extends along the sloped floor section;
the spaced apart raised ridges are positioned between selected instances of the spaced apart raised ribs that extend from the sloped floor section; and
instances of the spaced apart raised ridges are spaced apart from each other, and are aligned along a row extending along a central section of the sloped floor section.

18. The apparatus of claim 5, wherein:
the paint-roller engaging device includes:
a first bracket assembly; and
a second bracket assembly being spaced apart from the first bracket assembly.

19. The apparatus of claim 5, further comprising:
a ladder-engagement device includes:
a first bracket assembly; and
a second bracket assembly being spaced apart from the first bracket assembly; and
the first bracket assembly and the second bracket assembly being mounted to one of the spaced apart peripheral end walls proximate to a top section of a sloped floor section.

20. An apparatus for a paint roller, the apparatus comprising:
a paint-receivable tray, including:
a sloped floor section being configured to facilitate movement of paint flow once paint is received by the sloped floor section;
spaced apart raised ribs extending upwardly from the sloped floor section, and the spaced apart raised ribs being configured to urge movement of excess paint from the paint roller toward a portion of the sloped floor section once the paint roller is rolled along a length of the sloped floor section just so;
a paint collection well extending from the sloped floor section, and the paint collection well being configured to receive paint flow from the sloped floor section;
spaced apart peripheral lateral sidewalls extending along opposite elongated lateral sides of the sloped floor section and the paint collection well, and the spaced apart peripheral lateral sidewalls being configured to extend toward and contact a working surface once the paint-receivable tray is placed on the working surface; and
spaced apart peripheral end walls extending along opposite end sides of the sloped floor section and the paint collection well, the spaced apart peripheral end walls being oriented perpendicularly to the spaced apart peripheral lateral sidewalls, and the spaced apart peripheral end walls being configured to extend toward and remain spaced apart from the working surface once the paint-receivable tray is placed on the working surface in such a way that a sliding resistance of the paint-receivable tray is reduced, at least in part, once the paint-receivable tray is urged to travel along the working surface, while remaining in contact with the working surface through a travel direction that extends along a laterally-extending length of the spaced apart peripheral lateral sidewalls.
